(19) United States
(12) Patent Application Publication
(10) Pub. No.: US 2017/0361431 A1
(43) Pub. Date: Dec. 21, 2017

(54) FASTENER REMOVAL APPARATUS

(71) Applicant: ROBERT LAMBERTUS DEKAM, LANGLEY (CA)

(72) Inventor: ROBERT LAMBERTUS DEKAM, LANGLEY (CA)

(21) Appl. No.: 15/185,391

(22) Filed: Jun. 17, 2016

(51) Int. Cl. B25B 13/48; B25B 13/10; B25B 17/00; B25B 21/00

(52) U.S. Cl. CPC B25B 13/488; B25B 21/002; B25B 13/102; B25B 17/00

(57) ABSTRACT

A fastener removal apparatus is configured for removing a nut from a threaded shank and includes a gearbox assembly, an outer socket, and a tubular sleeve member. The gearbox assembly has an input member, a first output member, a second output member, and a plurality of gears. The first output member and the second output member rotation in opposite directions about a longitudinal axis in response to rotation imparted to the input member. The outer socket extends between a first end defining a female polygonal opening and a second end engaged for concurrent rotation with the first output member. The tubular sleeve member extends between a first end defining a threaded opening for receiving threads defined by the threaded shank and a second end engaged for concurrent rotation with the second output member.

### BACKGROUND

### 1. Field

The present disclosure relates to a fastener removal apparatus for removing fasteners that require a high level of force to remove.

### 2. Description of Related Prior Art

U.S. Pat. No. 2,479,225 discloses a GEAR OPERATED DUAL WRENCH. This invention relates to wrenches and more particularly to a wrench adapted to facilitate the application and removal of outer nuts to or from sleeve nuts, that is, to provide torque in two directions simultaneously to two co-axial nuts and alternatively, by the use of a part of a wrench, to apply torque directly to one of said nuts.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A fastener removal apparatus is configured for removing a nut from a threaded shank. The fastener removal apparatus includes a gearbox assembly, an outer socket, and a tubular sleeve member. The gearbox assembly has an input member, a first output member, a second output member, and a plurality of gears disposed between the input member and the first output member such that the first output member and the second output member rotation in opposite directions about a longitudinal axis in response to rotation imparted to the input member. The outer socket extends along and is centered on the longitudinal axis between a first end defining a female polygonal opening for mating with the fastening nut and a second end spaced from the first end along the longitudinal axis and engaged for concurrent rotation with the first output member. The tubular sleeve member is surrounded by the outer socket. The tubular sleeve member extends along and is centered on the longitudinal axis between a first end defining a threaded opening for receiving threads defined by the threaded shank and a second end spaced from the first end along the longitudinal axis and engaged for concurrent rotation with the second output member.

### BRIEF DESCRIPTION OF THE DRAWINGS

The detailed description set forth below references the following drawings:

FIG. 1 is a cross-section of a fastener removal apparatus according to an exemplary embodiment of the present disclosure;

FIG. 2 is a cross-section of a tubular sleeve member of a fastener removal apparatus according to another exemplary embodiment of the present disclosure;

FIG. 3 is a cross-section of a tubular sleeve member and an outer socket of a fastener removal apparatus according to another exemplary embodiment of the present disclosure;

FIG. 4 is a cross-section taken through section lines 4-4 in FIG. 3;

FIG. 5 is a cross-section of a tubular sleeve member and an outer socket of a fastener removal apparatus according to another exemplary embodiment of the present disclosure;

FIG. 6 is a cross-section taken through section lines 6-6 in FIG. 5;

FIG. 7 is a cross-section of a tubular sleeve member of a fastener removal apparatus according to another exemplary embodiment of the present disclosure;

FIG. 8 is a cross-section of a tubular sleeve member of a fastener removal apparatus according to another exemplary embodiment of the present disclosure;

FIG. 9 is a cross-section of a tubular sleeve member of a fastener removal apparatus according to another exemplary embodiment of the present disclosure;

FIG. 10 is a cross-section of a tubular sleeve member and an outer socket of a fastener removal apparatus according to another exemplary embodiment of the present disclosure;

FIG. 11 is a cross-section taken through section lines 11-11 in FIG. 10;

FIG. 12 is a cross-section taken through section lines 12-12 in FIG. 10;

FIG. 13 is a cross-sectional view take through section lines 13-13 in FIG. 2; and

FIG. 14 is a perspective view of a portion of the tubular sleeve assembly according to another exemplary embodiment of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiment described below, can provide a fastener removal apparatus for removing fasteners that require a high level of force to remove. The fastener removal apparatus obviates the need for a reaction arm. The fastener removal apparatus can impart load on a bolt while the nut fastened to the bolt is loosened. Thus, the fastener removal apparatus embodies the method of imparting reaction force on the subject bolt (the bolt encircled by the fastener to be removed) rather than on some other structure and rather than through a reaction arm, also allowing an adjustable flex joint to be used, which cannot be through a reaction arm.

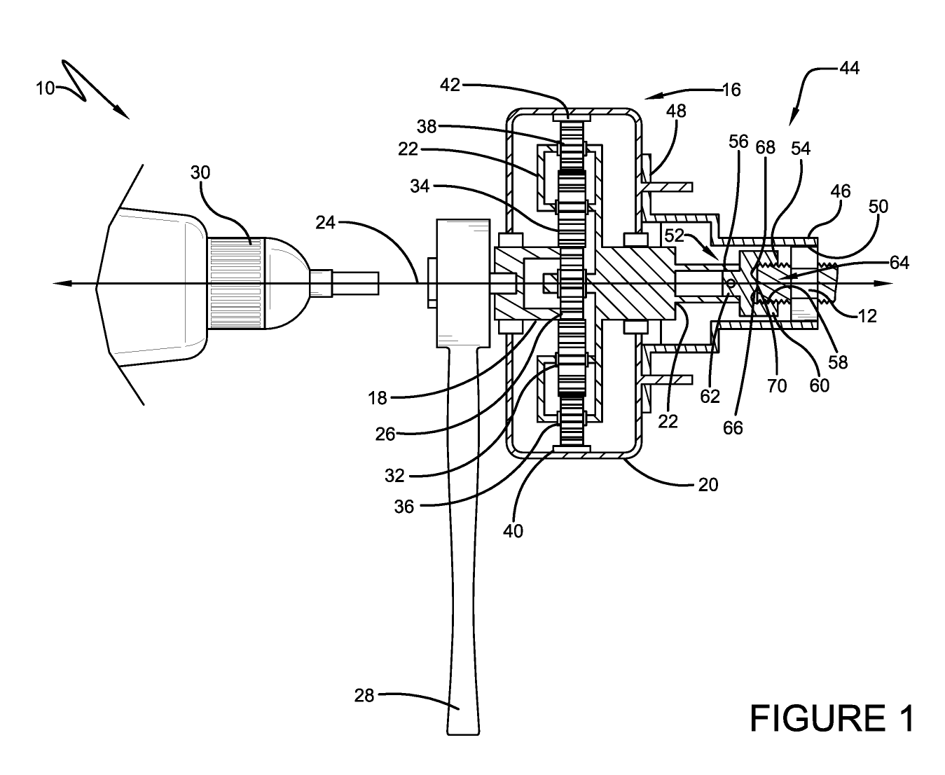

Referring now to FIG. 1, a fastener removal apparatus 10 is configured for removing a nut 12 from a threaded shank 14. The fastener removal apparatus 10 includes a gearbox assembly 16. The gearbox assembly 16 has an input member 18, a first output member 20, a second output member 22, and a plurality of gears disposed between the input member 18 and the first output member 20 such that the first output member 20 and the second output member 22 rotation in opposite directions about a longitudinal axis 24 in response to rotation imparted to the input member 18.

The plurality of gears can include a sun gear 26 fixed for rotation with the input member 18. The sun gear 26 can be rotated by a wrench 28 or by a drill 30. The plurality of gears can include intermediate planetary gears, such as gears 32, 34. The gears 32, 34 can be meshed with the sun gear 26. The gears 32, 34 can be supported on the second output member 22. The second output member 22 can act as a gear carrier. The plurality of gears can include outer planetary gears, such as gears 36, 38. The gears 36, 38 can be meshed with the intermediate planetary gears 32, 34. The gears 36, 38 can also be supported on the second output member 22. The first output member 20 can include inwardly-directed gear teeth, such as teeth 40, 42. The teeth 40, 42 can be meshed with the outer planetary gears 36, 38. In an exemplary operation, rotation in a first rotational direction that is imparted to the input member 18 is transmitted through the plurality of gears and results in rotation of the first output member 20 in the first rotational direction and rotation of the second output member 22 in a second rotational direction that is opposite to the first rotational direction.

The fastener removal apparatus 10 includes an outer socket 44. The outer socket 44 extends along and is centered on the longitudinal axis 24 between a first end 46 and a second end 48. The first end 46 can define a female polygonal opening 50 for mating with the fastening nut 12. A polygon is a plane figure (two dimensional) with at least three straight sides. A polygonal opening is an opening that includes at least three straight sides. The female polygonal opening 50 mates with the fastening nut 12 in that the female polygonal opening 50 receives the fastening nut 12 and the two components will rotate together. The second end 48 can be spaced from the first end 46 along the longitudinal axis 24 and engaged for concurrent rotation with the first output member 20.

The fastener removal apparatus 10 includes a tubular sleeve member 52. The tubular sleeve member 52 is surrounded by the outer socket 44. The tubular sleeve member 52 extends along and is centered on the longitudinal axis 24 between a first end 54 defining a threaded opening 58 for receiving threads defined by the threaded shank 14 and a second end 56 spaced from the first end 54 along the longitudinal axis 24 and engaged for concurrent rotation with the second output member 22.

The exemplary tubular sleeve member 52 includes tubular sleeve portion 60 and a driver portion 62. The tubular sleeve portion 60 can include the first end 54 and the threaded opening 58. The driver portion 62 can include the second end 56 of the tubular sleeve member 52 and can be engaged for concurrent rotation with the second output member 22.

In the first exemplary embodiment of the present disclosure, the tubular sleeve portion 60 and the driver portion 62 are integrally-formed with respect to one another. “Integrally-formed” refers to the fact that in the exemplary embodiment the the tubular sleeve portion 60 and the driver portion 62 are formed together rather than being formed separately and then subsequently joined. The term defines a structural feature since structures that are integrally-formed are structurally different than structures that are comprised of subcomponents formed separately and then subsequently joined. “Integral” means consisting or composed of parts that together constitute a whole and thus encompasses structures of more than one part wherein the parts are either integrally-formed or formed separately and then subsequently joined.

The tubular sleeve member 52 also includes a blind aperture 64 and a protuberance 66. The blind aperture 64 can be defined by the tubular sleeve portion 60 in cooperation with the driver portion 62. The blind aperture 64 can be centered on the longitudinal axis 24 and open toward the first end 54. The blind aperture 64 can have a floor 68. The protuberance 66 can project along the longitudinal axis 24 away from the floor 68 toward the threaded opening 58. The protuberance 66 can have a tip 70 spaced from the floor 68. The tip 70 can have a diameter smaller than a diameter of the blind aperture 64.

In an exemplary method of using the first embodiment, the exemplary tubular sleeve member 52 can be screwed onto the shank 14, the threads of the tubular sleeve portion 60, disposed in the blind aperture 64, threaded on the threads of the shank 14. The tubular sleeve member 52 can be screwed onto the shank 14 until the tip 70 contacts the distal end of the shank 14. The second output member 22 can then mate with the driver portion 62 and, concurrently, the female polygonal opening 50 of the first output member 20 can mate with the nut 12. Rotation can then be input to the input member 18, resulting in the breaking of the engagement between the threads of the nut 12 and the threads of the shank 14. After the engagement between the threads of the nut 12 and the threads of the shank 14 is broken, the fastener removal apparatus 10 can be removed and the nut 12 can be removed with a wrench or by hand. A wrench can also be used to remove the tubular sleeve member 52 from the shank 14.

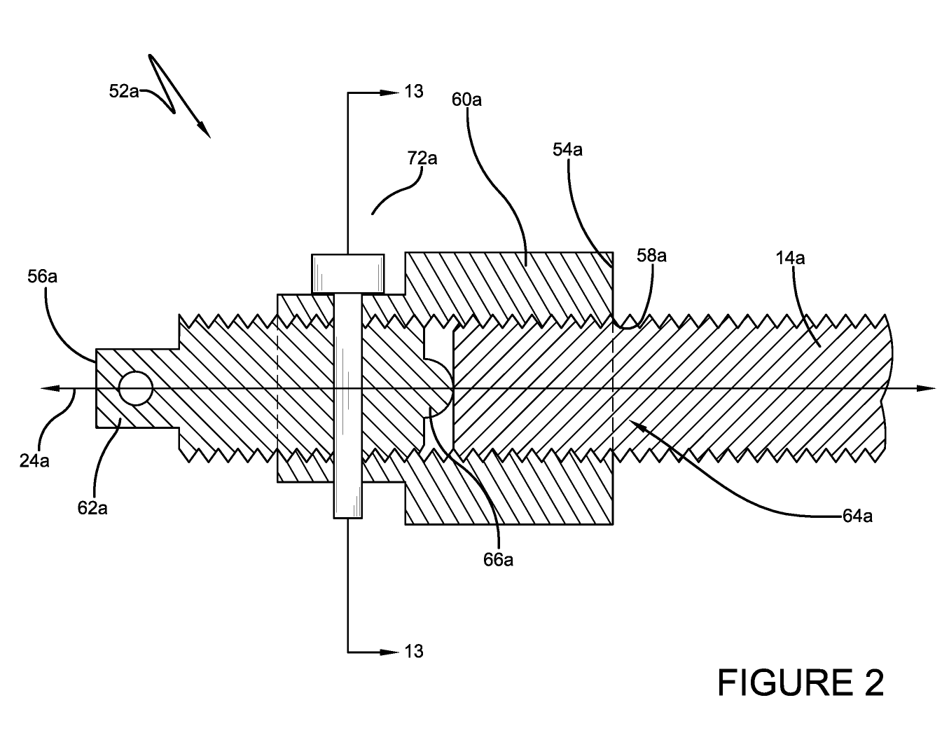

FIG. 2 is a cross-section of a tubular sleeve member 52a of a fastener removal apparatus according to another exemplary embodiment of the present disclosure. The tubular sleeve member 52a extends along and is centered on a longitudinal axis 24a between a first end 54a defining a threaded opening 58a for receiving threads defined by a threaded shank 14a and a second end 56a spaced from the first end 54a along the longitudinal axis 24a and engageable for concurrent rotation with a second output member such as the second output member 22.

The exemplary tubular sleeve member 52a includes tubular sleeve portion 60a and a driver portion 62a. The tubular sleeve portion 60a can include the first end 54a and the threaded opening 58a. The driver portion 62a can include the second end 56a. In the second exemplary embodiment of the present disclosure, the tubular sleeve portion 60a and the driver portion 62a are threadingly-engaged with respect to one another. The tubular sleeve member 52a also includes a blind aperture 64a and a protuberance 66a, similar to the blind aperture 64 and protuberance 66 of the first embodiment. The exemplary tubular sleeve member 52a can also include a pin 72a extending perpendicular to the longitudinal axis 24a. The pin 72a can pass through at least part of the tubular sleeve portion 60a and at least part of the driver portion 62a.

In an exemplary method of using the second embodiment, the exemplary tubular sleeve member 52a can be screwed onto the shank 14a, the threads of the tubular sleeve portion 60a, disposed in the blind aperture 64a, threaded on the threads of the shank 14a. The tubular sleeve member 52a can be screwed onto the shank 14a until the tip of the protuberance 66a contacts the distal end of the shank 14a. A second output member can then mate with the driver portion 62a and, concurrently, a female polygonal opening of a first output member can mate with a nut on the shank 14a. Rotation can then be input to an input member, resulting in the breaking of the engagement between the threads of the nut and the threads of the shank 14a. After the engagement between the threads of the nut and the threads of the shank 14a is broken, the fastener removal apparatus can be removed and the nut can be removed with a wrench or by hand. A wrench can also be used to remove the tubular sleeve member 52a from the shank 14a.

The second exemplary embodiment can include structure to accommodate or permit lost motion between the tubular sleeve portion 60a and a driver portion 62a over less than three hundred and sixty degrees. After input rotation, such as in the first rotational direction, is applied to break the engagement between the threads of the nut and the threads of the shank 14a, the driver portion 62a can be rotated in a second rotational direction opposite to the first rotational direction, relative to the tubular sleeve portion 60a this can allow the protuberance 66a to be backed-off from the shank 14a, thereby reducing the compressive loading generated during the breaking of the engagement between the threads of the nut and the threads of the shank 14a. This can reduce the force required to break the engagement between the threads of the tubular sleeve portion 60a and the threads of the shank 14a.

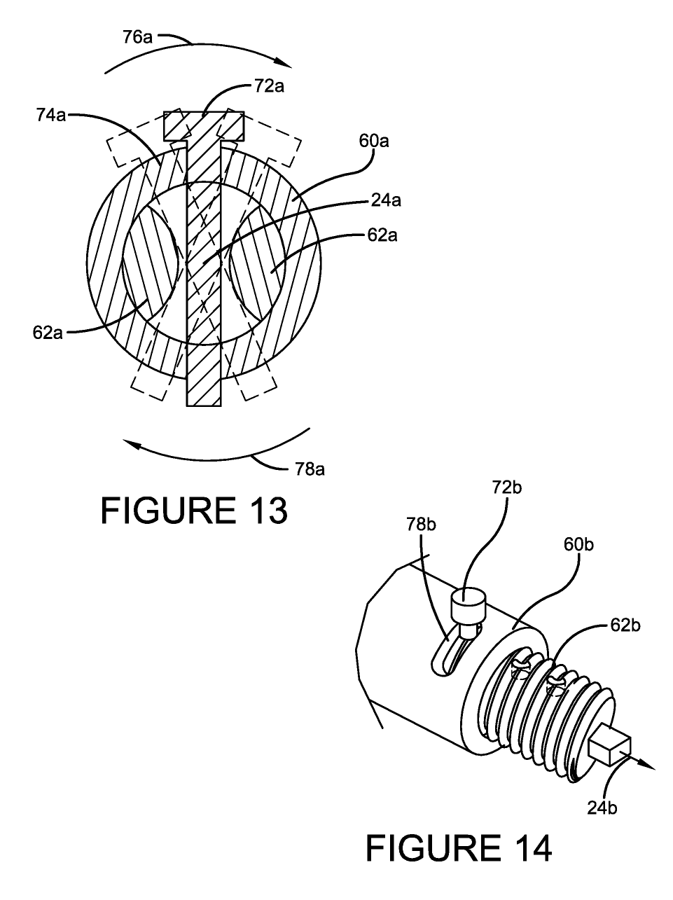

In the second exemplary embodiment, lost motion can be achieved in at least two different ways. In a first approach, the pin 72a can be received in a slot 74a in the driver portion 62a that extends around the longitudinal axis 24a. This is shown in FIG. 13. Arrows indicate the extension of the slot 74a about the longitudinal axis 24a. During concurrent rotation of the tubular sleeve portion 60a and the driver portion 62a in the first rotational direction as the engagement between the threads of the nut and the threads of the shank 14a is broken, the pin 72a can be in the position (relative to the slot 74a) shown in phantom clockwise of the pin 72a shown in solid line. During relative rotation of the driver portion 62a relative to the tubular sleeve portion 60a in the second rotational direction 78a as the protuberance 66a is drawn back from the shank 14a, the pin 72a can be in the position (relative to the slot 74a) shown in phantom counter-clockwise of the pin 72a is solid line.

In a second approach, a pin 72b can be received in a slot 78b in the tubular sleeve portion 60b that extends around the longitudinal axis 24b. This is shown as another exemplary embodiment of the present disclosure in FIG. 14. A slot mirroring slot 78b can be defined on the underside of the tubular sleeve portion 60b that is not visible in FIG. 14. Also, multiple slots could be formed in tubular sleeve portion 60b, spaced along the axis 24b to accommodate different operating environments. Such an embodiment could have spring loaded shaft keys/pins. In the first approach, the pin 72a can be fixed with tubular sleeve portion 60a for rotation. In the second approach, the pin 72b can be fixed with driver portion 62b for rotation.

The tubular sleeve portion 60a and the driver portion 62a are thus threadingly-engaged with respect to one another such that in response to rotation of the driver portion 62 in the first rotational direction over at least some angular range, the tubular sleeve portion 60 is driven in the first rotational direction. The angular range can be greater or less than three hundred and sixty degrees. Also, the tubular sleeve portion 60a and the driver portion 62a are threadingly-engaged with respect to one another such that in response to rotation of the driver portion 62a in the second rotational direction opposite to the first rotational direction over the angular range, the tubular sleeve portion 60a is not driven in the second rotational direction. The extent of relative rotation permitted can vary as desired. For example, the various approaches shown in FIGS. 13 and 14 can permit an angular range as a one-quarter or less turn of the driver portion and the tubular sleeve portion relative to one another.

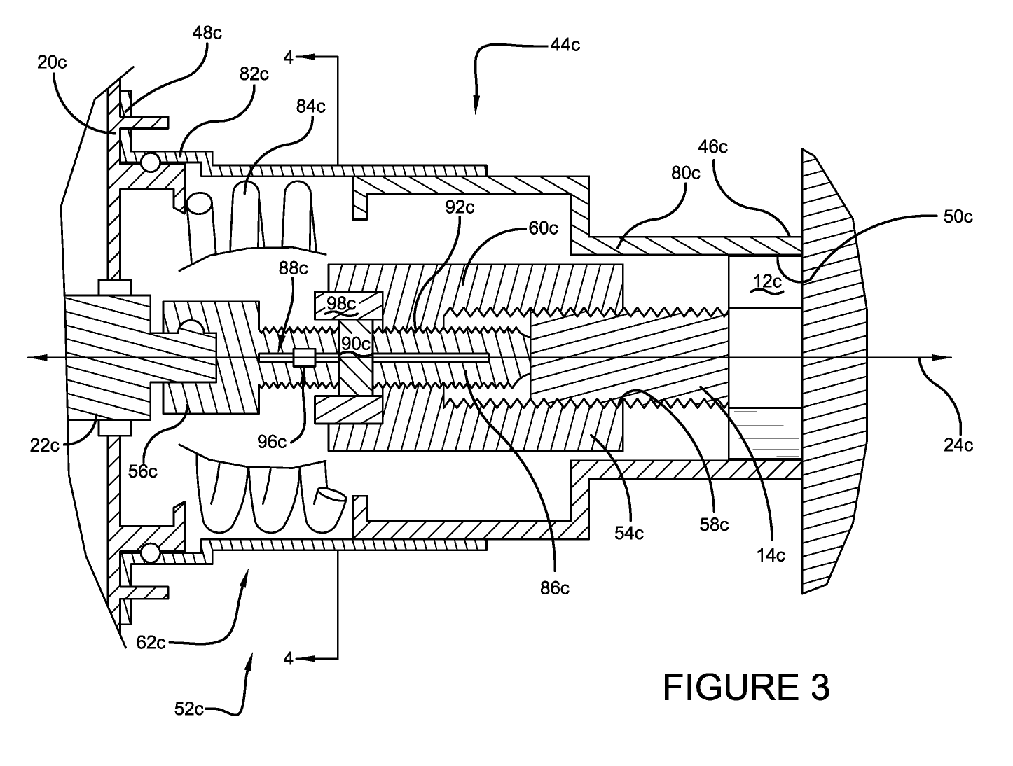

FIG. 3 is a cross-section of a tubular sleeve member 52c and an outer socket 44c of a fastener removal apparatus according to another exemplary embodiment of the present disclosure. The outer socket 44c can include a first socket portion 80c and a second socket portion 82c. The first socket portion 80c can include the first end 46c of the outer socket 44c and the female polygonal opening 50c. The second socket portion 82c can include the second end 48c of the outer socket 44c and can be engaged for concurrent rotation with a first output member 20c. The first socket portion 80c and the second socket portion 82c can be telescopically engaged with one another. A spring 84c can bias the first socket portion 80c away from the second socket portion 82c and away from the first output member 20c to maximize the length of the outer socket 44c along the longitudinal axis 24c. The outer socket 44c can be telescopically retracted by urging the first socket portion 80c into the second socket portion 82c, against the biasing force exerted by the spring 84c. One or more embodiments of the present disclosure can include one or more clips to retain the outer socket 44c in the telescopically retracted condition.

The tubular sleeve member 52c extends along and is centered on a longitudinal axis 24c between a first end 54c defining a threaded opening 58c for receiving threads defined by a threaded shank 14c and a second end 56c spaced from the first end 54c along the longitudinal axis 24c and engageable for concurrent rotation with a second output member 22c.

The exemplary tubular sleeve member 52c includes tubular sleeve portion 60c and a driver portion 62c. The tubular sleeve portion 60c can include the first end 54c and the threaded opening 58c. The driver portion 62c can include the second end 56c. In the third exemplary embodiment of the present disclosure, the tubular sleeve portion 60c and the driver portion 62c are threadingly-engaged with respect to one another.

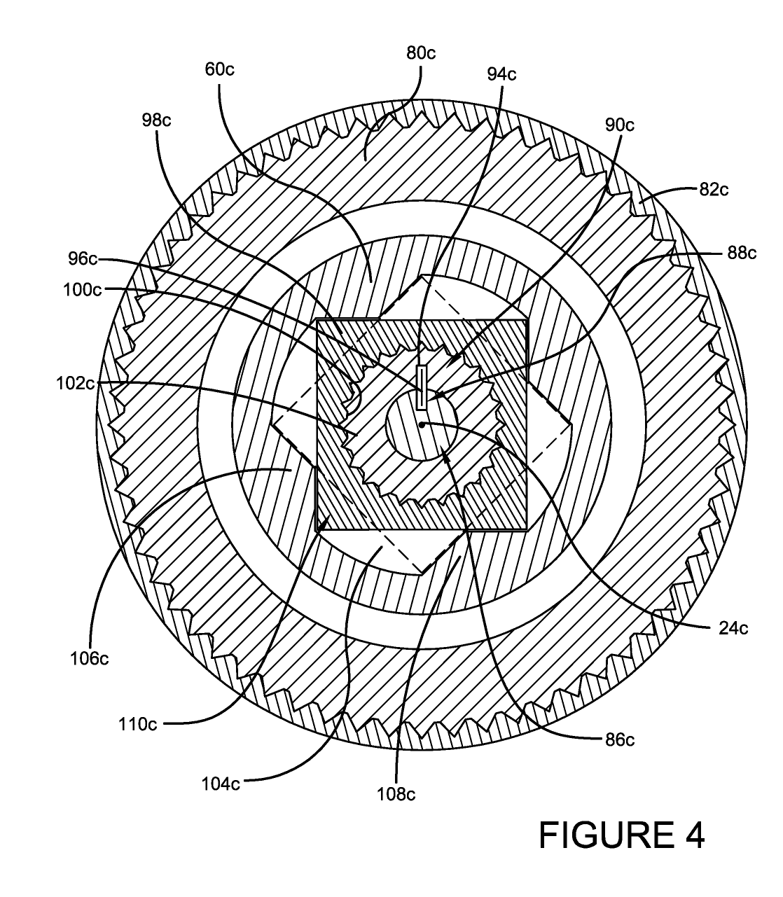

The exemplary driver portion 62c includes a base portion 86c being a threaded shank and including a slot 88c extending along the longitudinal axis 24c. The exemplary driver portion 62c can also include a ring 90c. The ring 90c can be threadingly engaged with the base portion 86c. The ring 90c can allow the base portion 86c to be adjustably positioned relative to the tubular sleeve portion 60c. For example, during initial positioning, the extent that the base portion 86c extends through a threaded aperture 92c of the tubular sleeve portion 60c can be limited by the position of the ring 90c along the base portion 86c. The ring 90c can be sized to prevent passage through the aperture 92c. The ring 90c can also include a slot 94c, visible in FIG. 4.

The exemplary driver portion 62c can also include a key 96c. The key 96c can be mounted in the slot 88c for sliding movement. The key 96c can be selectively received in the slot 94c. When the key 96c is received in the slot 94, the ring 90c and the base portion 86c are locked together for concurrent rotation in the same direction.

The exemplary driver portion 62c can also include a nut 98c. The nut 98c can have aperture 100c defining splines. The ring 90c can have an outer surface 102c defining splines. The splines of the nut 98c and the splines of the outer surface 102c can engage one another to lock the nut 98c and the ring 90c together for concurrent rotation in the same direction.

FIG. 4 is a cross-section perpendicular to the longitudinal axis 24c. FIGS. 3 and 4 show at least some length of overlap of the tubular sleeve portion 60c and the driver portion 62c along the longitudinal axis 24c. FIG. 4 shows a radial gap 104c is defined between the tubular sleeve portion 60c and the driver portion 62c (represented by the nut 98c). The exemplary radial gap 104c extends an angular distance about the longitudinal axis 24 less than three hundred and sixty degrees. The tubular sleeve portion 60c defines a first shoulder 106c and a second shoulder 108c each extending radially with respect to the longitudinal axis 24c and spaced from one another about the longitudinal axis 24c. The first shoulder 106c and a second shoulder 108c thereby define the angular distance of the radial gap 104c; the angular distance between the shoulders 106c, 108c is the distance of the radial gap 104c. The nut 98c of the driver portion 62c defines a protuberance 110c (in the form of a corner) extending radially in the radial gap 104c between the first shoulder 106c and the second shoulder 108c.

In an exemplary method of using the third embodiment, the exemplary outer socket 44c can be telescopically retracted by drawing the first socket portion 80c against the spring 84c and into the second socket portion 82c. The exemplary tubular sleeve member 52c can then be screwed onto the shank 14c, the threads of the tubular sleeve portion 60c threaded on the threads of the shank 14c. The tubular sleeve member 52c can be screwed onto the shank 14c until the tip or distal end of the base portion 86c contacts the distal end of the shank 14c. The key 96c can then be inserted in the slot 94c and the nut 98c can be positioned to surround the ring 90c so that the splines of the nut 98c and the ring 90c are meshed. The first socket portion 80c can then be released so that the output socket 44c telescopically expands and the female polygonal opening 50c mates with a nut 12c on the shank 14c. Rotation in a first rotational direction can then be input to an input member, resulting in the breaking of the engagement between the threads of the nut 12c and the threads of the shank 14c. During this rotation in the first rotational direction, the protuberance 110c can press against the shoulder 106c.

After the engagement between the threads of the nut 12c and the threads of the shank 14c is broken, the first socket portion 80c can be drawn back into the second socket portion to disengage the female polygonal opening 50c from the nut 12c. Rotation in a second rotational direction opposite to the first rotational direction can then be input to an input member, initially resulting in the protuberance 110c traversing the radial gap 104c to contact and press against the shoulder 108c. During this initial movement, the compressive force applied to the distal end of the shank 14c by the base portion 86c is eliminated or diminished, dropping the torque required to unscrew the tubular sleeve portion 60c from the shank 14c. Further rotation in the second rotational direction unscrews the tubular sleeve portion 60c from the shank 14c.

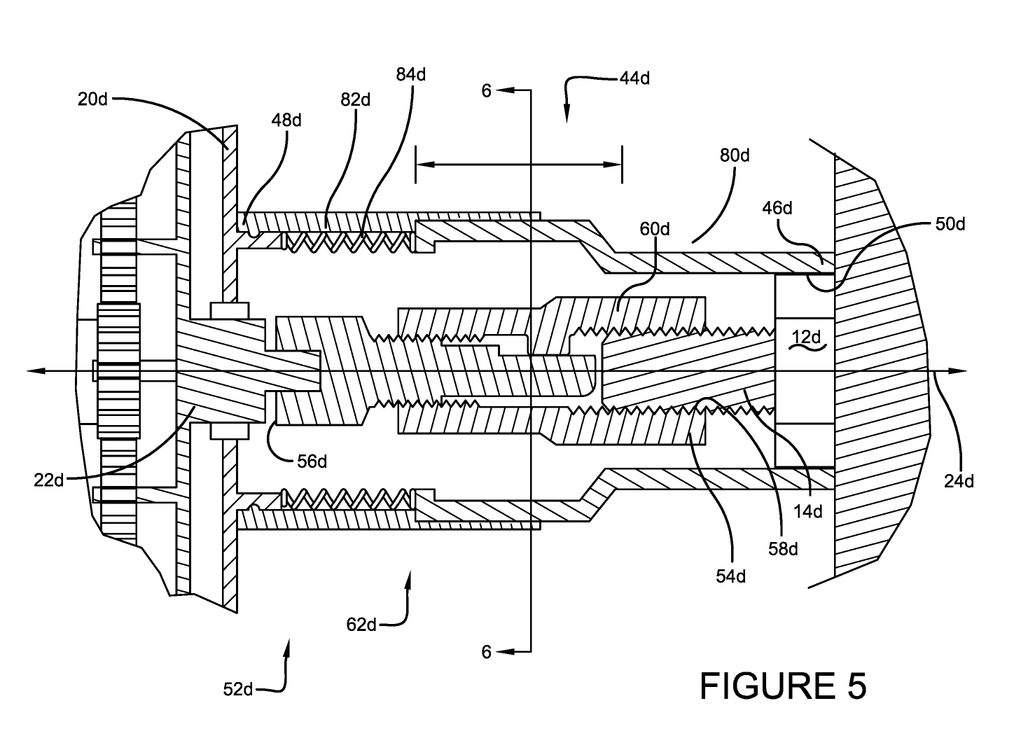

FIG. 5 is a cross-section of a tubular sleeve member 52d and an outer socket 44d of a fastener removal apparatus according to another exemplary embodiment of the present disclosure. The outer socket 44d can include a first socket portion 80d and a second socket portion 82d. The first socket portion 80d can include the first end 46d of the outer socket 44d and the female polygonal opening 50d. The second socket portion 82d can include the second end 48d of the outer socket 44d and can be engaged for concurrent rotation with a first output member 20d. The first socket portion 80d and the second socket portion 82d can be telescopically engaged with one another. A spring 84d can bias the first socket portion 80d away from the second socket portion 82d and away from the first output member 20d to maximize the length of the outer socket 44d along the longitudinal axis 24d. The outer socket 44d can be telescopically retracted by urging the first socket portion 80d into the second socket portion 82d, against the biasing force exerted by the spring 84d. One or more embodiments of the present disclosure can include one or more clips to retain the outer socket 44d in the telescopically retracted condition.

The tubular sleeve member 52d extends along and is centered on a longitudinal axis 24d between a first end 54d defining a threaded opening 58d for receiving threads defined by a threaded shank 14d and a second end 56d spaced from the first end 54d along the longitudinal axis 24d and engageable for concurrent rotation with a second output member 22d.

The exemplary tubular sleeve member 52d includes tubular sleeve portion 60d and a driver portion 62d. The tubular sleeve portion 60d can include the first end 54d and the threaded opening 58d. The driver portion 62d can include the second end 56d. In the third exemplary embodiment of the present disclosure, the tubular sleeve portion 60d and the driver portion 62d are threadingly-engaged with respect to one another.

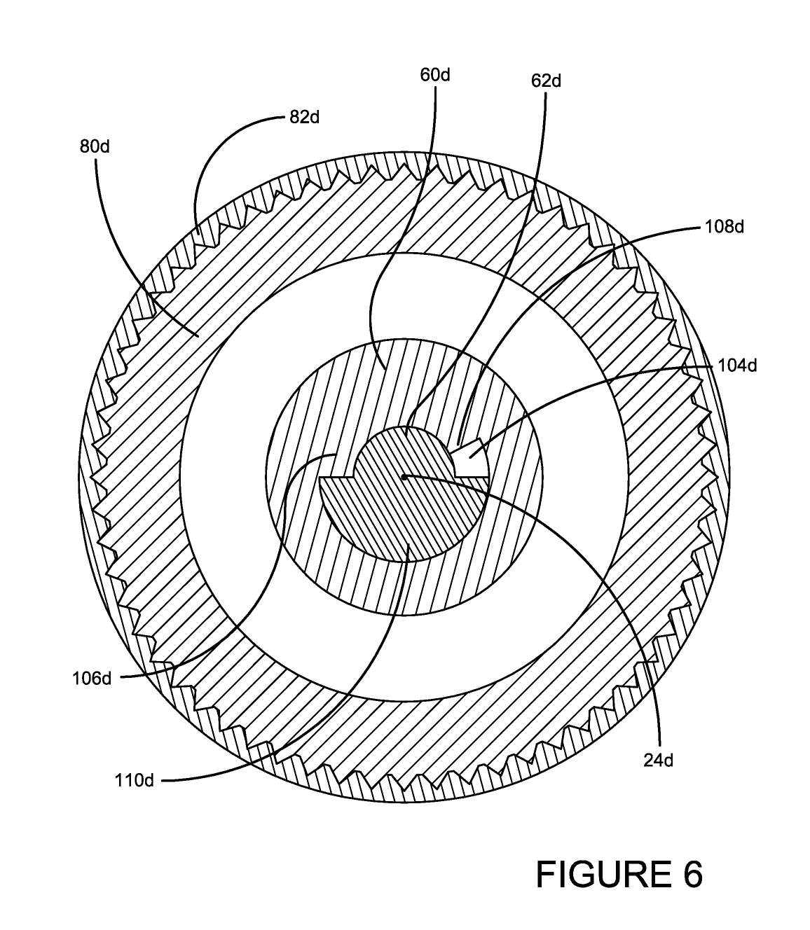

FIG. 6 is a cross-section perpendicular to the longitudinal axis 24d. FIGS. 5 and 6 show at least some length of overlap of the tubular sleeve portion 60d and the driver portion 62d along the longitudinal axis 24d. FIG. 6 shows a radial gap 104d is defined between the tubular sleeve portion 60d and the driver portion 62d. The exemplary radial gap 104d extends an angular distance about the longitudinal axis 24d less than three hundred and sixty degrees. The tubular sleeve portion 60d defines a first shoulder 106d and a second shoulder 108d each extending radially with respect to the longitudinal axis 24d and spaced from one another about the longitudinal axis 24d. The first shoulder 106d and a second shoulder 108d thereby define the angular distance of the radial gap 104d; the angular distance between the shoulders 106d, 108d is the distance of the radial gap 104d. The driver portion 62d defines a protuberance 110d extending radially in the radial gap 104d between the first shoulder 106d and the second shoulder 108d.

In an exemplary method of using the fourth embodiment, the exemplary outer socket 44d can be telescopically retracted by drawing the first socket portion 80d against the spring 84d and into the second socket portion 82d. The exemplary tubular sleeve member 52d can then be screwed onto the shank 14d, the threads of the tubular sleeve portion 60d threaded on the threads of the shank 14d. The tubular sleeve member 52d can be screwed onto the shank 14d until the tip or distal end of the driver portion 62d contacts the distal end of the shank 14d. The first socket portion 80d can then be released so that the output socket 44d telescopically expands and the female polygonal opening 50d mates with a nut 12d on the shank 14d. Rotation in a first rotational direction can then be input to an input member, resulting in the breaking of the engagement between the threads of the nut 12d and the threads of the shank 14d. During this rotation in the first rotational direction, the protuberance 110d can press against the shoulder 106d.

After the engagement between the threads of the nut 12d and the threads of the shank 14d is broken, the first socket portion 80d can be drawn back into the second socket portion to disengage the female polygonal opening 50d from the nut 12d. Rotation in a second rotational direction opposite to the first rotational direction can then be input to an input member, initially resulting in the protuberance 110d traversing the radial gap 104d to contact and press against the shoulder 108d. During this initial movement, the compressive force applied to the distal end of the shank 14d by the base portion 86d is eliminated or diminished, dropping the torque required to unscrew the tubular sleeve portion 60d from the shank 14d. Further rotation in the second rotational direction unscrews the tubular sleeve portion 60d from the shank 14d.

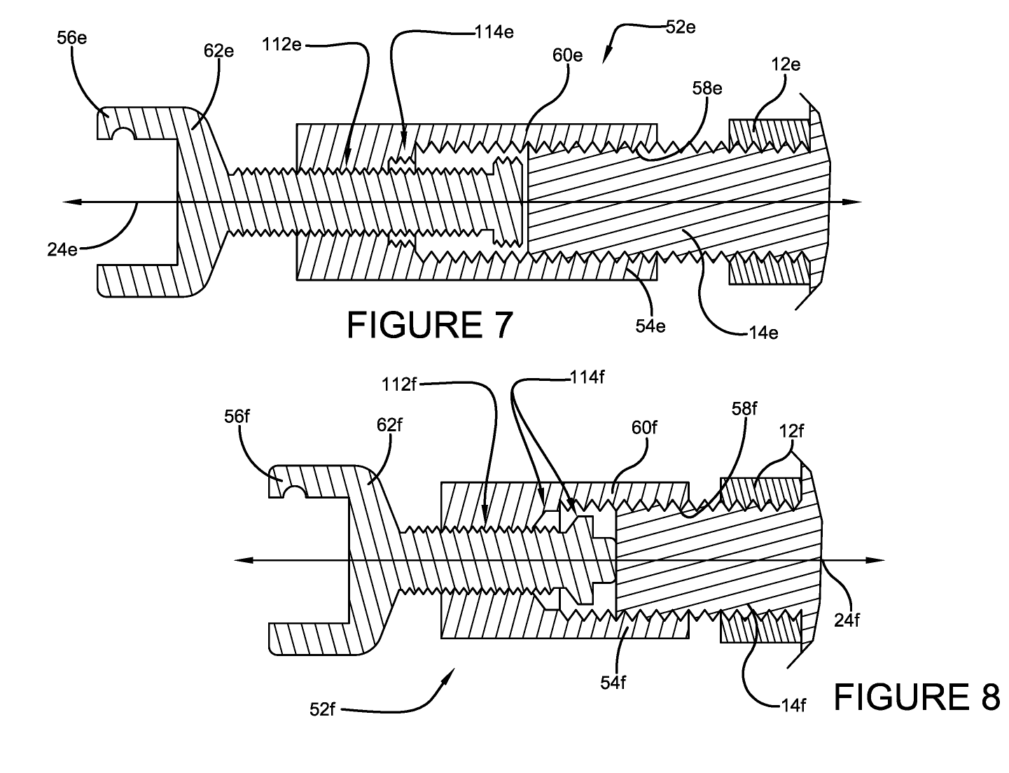

FIG. 7 is a cross-section of a tubular sleeve member 52e of a fastener removal apparatus according to another exemplary embodiment of the present disclosure. The tubular sleeve member 52e extends along and is centered on a longitudinal axis 24e between a first end 54e defining a threaded opening 58e for receiving threads defined by a threaded shank 14e and a second end 56e spaced from the first end 54e along the longitudinal axis 24e and engageable for concurrent rotation with a second output member.

The exemplary tubular sleeve member 52e includes tubular sleeve portion 60e and a driver portion 62e. The tubular sleeve portion 60e can include the first end 54e and the threaded opening 58e. The driver portion 62e can include the second end 56e. In the third exemplary embodiment of the present disclosure, the tubular sleeve portion 60e and the driver portion 62e are threadingly-engaged with respect to one another.

The exemplary tubular sleeve portion 60e and driver portion 62e are threadingly-engaged through a first pair of mating threads (referenced at 112e) and a second pair (referenced at 114e) of mating threads. The exemplary first pair 112e of mating threads and the second pair 114e of mating threads have different diameters. In this exemplary embodiment of the present disclosure, in response to rotation of the driver portion 62e in a first rotational direction over a first angular range, the driver portion 62e and the tubular sleeve portion 60e are threadingly-engaged only through the first pair 112e of mating threads and the tubular sleeve portion 60e is not driven in the first rotational direction. In this example, the first rotational direction can be defined when a compressive load applied by the driver portion 62e on the shank 14e is being reduced, after the engagement between the threads of the nut 12e and the threads of the shank 14e has been broken.

In addition, the exemplary tubular sleeve portion 60e and driver portion 62e are threadingly-engaged such that in response to rotation of the driver portion 62e in the first rotational direction beyond the first angular range, the driver portion 62e and the tubular sleeve portion 60e are threadingly-engaged through both of the first pair 112e of mating threads the second pair 114e of mating threads and the tubular sleeve portion 60e is driven in the first rotational direction. Thus, in this embodiment, lost motion over more than three hundred and sixty degrees occurs between the tubular sleeve portion 60e and driver portion 62e during removal of the tubular sleeve portion 60e from the shank 14e.

FIG. 8 is a cross-section of a tubular sleeve member 52f of a fastener removal apparatus according to another exemplary embodiment of the present disclosure. The tubular sleeve member 52f extends along and is centered on a longitudinal axis 24f between a first end 54f defining a threaded opening 58f for receiving threads defined by a threaded shank 14f and a second end 56f spaced from the first end 54f along the longitudinal axis 24f and engageable for concurrent rotation with a second output member.

The exemplary tubular sleeve member 52f includes tubular sleeve portion 60f and a driver portion 62f. The tubular sleeve portion 60f can include the first end 54f and the threaded opening 58f. The driver portion 62f can include the second end 56f. In the third exemplary embodiment of the present disclosure, the tubular sleeve portion 60f and the driver portion 62f are threadingly-engaged with respect to one another.

The exemplary tubular sleeve portion 60f and driver portion 62f are threadingly-engaged through a first pair of mating threads, referenced at 112f, and by a mushroom head or flat surface arrangement, referenced at 114f. In this exemplary embodiment of the present disclosure, in response to rotation of the driver portion 62f in a first rotational direction over a first angular range, the driver portion 62f and the tubular sleeve portion 60f are threadingly-engaged only through the first pair 112f of mating threads and the tubular sleeve portion 60f is not driven in the first rotational direction. In this example, the first rotational direction can be defined when a compressive load applied by the driver portion 62f on the shank 14f is being reduced, after the engagement between the threads of the nut 12f and the threads of the shank 14f has been broken.

In addition, the exemplary tubular sleeve portion 60f and driver portion 62f are engaged such that in response to rotation of the driver portion 62f in the first rotational direction beyond the first angular range, the driver portion 62f and the tubular sleeve portion 60f are engaged for concurrent rotation through the Phillips-like arrangement 114f and the tubular sleeve portion 60f is driven in the first rotational direction. Thus, in this embodiment, lost motion over more than three hundred and sixty degrees occurs between the tubular sleeve portion 60f and driver portion 62f during removal of the tubular sleeve portion 60f from the shank 14f.

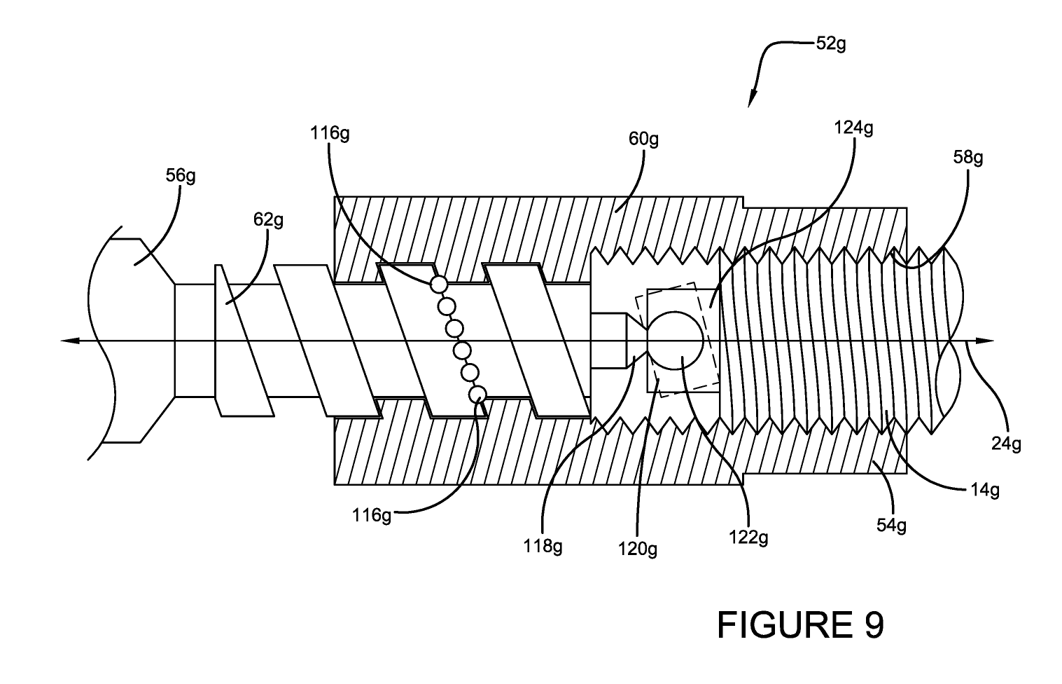

FIG. 9 is a cross-section of a tubular sleeve member 52g of a fastener removal apparatus according to another exemplary embodiment of the present disclosure. The tubular sleeve member 52g extends along and is centered on a longitudinal axis 24g between a first end 54g defining a threaded opening 58g for receiving threads defined by a threaded shank 14g and a second end 56g spaced from the first end 54g along the longitudinal axis 24g and engageable for concurrent rotation with a second output member.

The exemplary tubular sleeve member 52g includes tubular sleeve portion 60g and a driver portion 62g. The tubular sleeve portion 60g can include the first end 54g and the threaded opening 58g. The driver portion 62g can include the second end 56g. In the third exemplary embodiment of the present disclosure, the tubular sleeve portion 60g and the driver portion 62g are threadingly-engaged with respect to one another, with thread angles that release when input torque is ceased, relieving tension between threads for easy removal.

The tubular sleeve member 52g further comprises a plurality of bearings 116g. The plurality of bearings 116g can be mounted in one of the tubular sleeve portion 60g and the driver portion 62g. The plurality of bearings 116g can be operably disposed between the tubular sleeve portion 60g and the driver portion 62g.

The tubular sleeve member 52g can also include a mounting post 118g and a landing plate 120g. The mounting post 118g can be disposed at an end of the driver portion 62g opposite to the second end 56g of the tubular sleeve member 52g and can be at least partially spherical. The landing plate 120g can be disposed on the mounting post 118g. The landing plate 120g can define a recess 122g receiving at least a portion of the mounting post 118g on first side and a substantially flat surface 124g on a second side opposite the first side. The landing plate 120g can thus be configured to swivel relative to the mounting post 118g to accommodate distal ends of shanks 14e that do not define a plane that is perpendicular to the longitudinal axis 24g.

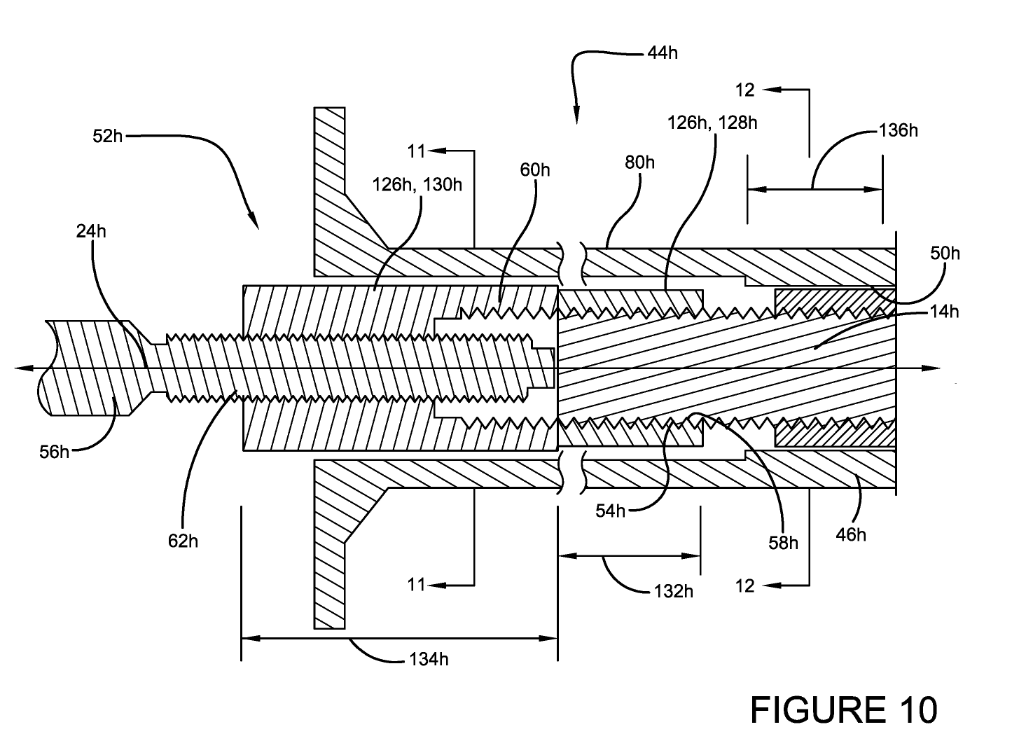

FIG. 10 is a cross-section of a tubular sleeve member 52h and an outer socket of a fastener removal apparatus according to another exemplary embodiment of the present disclosure. The outer socket can include a first socket portion 80h and a second socket portion. The first socket portion 80h can include a first end 46h of the outer socket and a female polygonal opening 50h. The first socket portion 80h and the second socket portion can be telescopically engaged with one another. A spring can bias the first socket portion 80h away from the second socket portion and away from a first output member to maximize the length of the outer socket along the longitudinal axis 24h. The outer socket can be telescopically retracted by urging the first socket portion 80h into the second socket portion, against the biasing force exerted by the spring. One or more embodiments of the present disclosure can include one or more clips to retain the outer socket in the telescopically retracted condition.

The tubular sleeve member 52h extends along and is centered on a longitudinal axis 24h between a first end 54h defining a threaded opening 58h for receiving threads defined by a threaded shank 14h and a second end 56h spaced from the first end 54h along the longitudinal axis 24h and engageable for concurrent rotation with a second output member.

The exemplary tubular sleeve member 52h includes tubular sleeve portion 60h and a driver portion 62h. The tubular sleeve portion 60h can include the first end 54h and the threaded opening 58h. The driver portion 62h can include the second end 56h. In the third exemplary embodiment of the present disclosure, the tubular sleeve portion 60h and the driver portion 62h are threadingly-engaged with respect to one another.

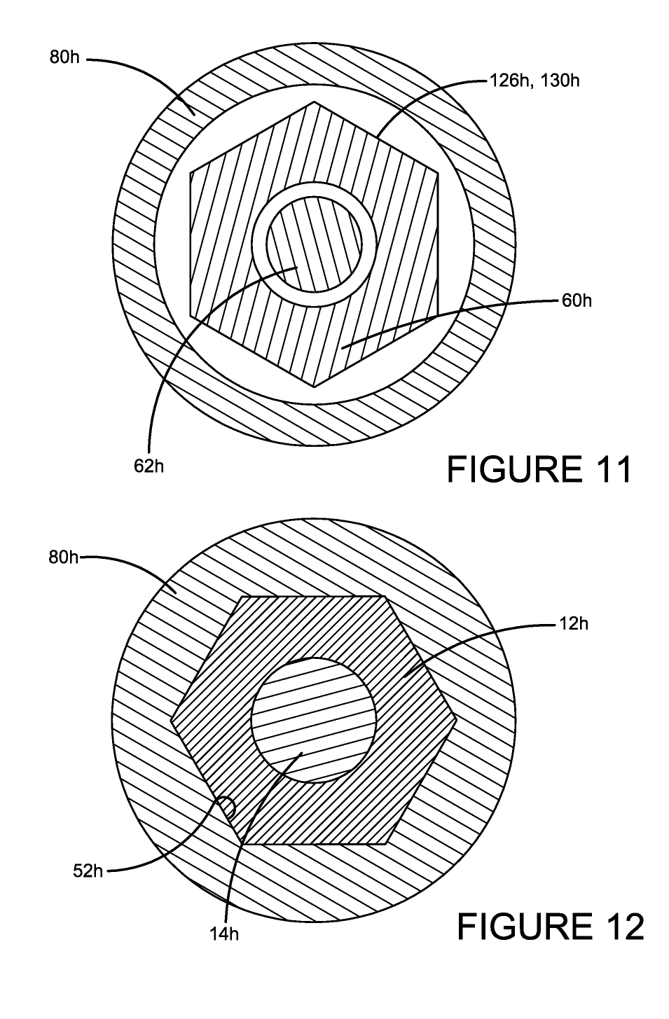

At least part of an outer surface 126h of the tubular sleeve portion 60h is sized and shaped to mate with the female polygonal opening 50h. The outer surface 126h of the tubular sleeve portion 60h includes a first portion 128h extending a first length 132h along the longitudinal axis 24h and having a circular cross-section with an outer diameter smaller than the female polygonal opening 50h. The outer surface 126h also includes a second portion 130h extending a second length 134h along the longitudinal axis 24h and defining the part of the outer surface 126h of the tubular sleeve portion 60h that is sized and shaped to mate with the female polygonal opening 50h. The first portion 128h is closer to the female polygonal opening 50h along the longitudinal axis 24h when the first socket portion 80h and the second socket portion 82h are fully telescopically extended with respect to one another. The female polygonal opening 50h extends a third length 136h along the longitudinal axis 24h. The first length 132h equal to or less than the third length 136h. FIGS. 11 and 12 are cross-sections perpendicular to the longitudinal axis 24h and show that the female polygonal opening 50h is sized and shaped to mate with the second portion 130h of the outer surface 126h.

In an exemplary method of using the fourth embodiment, the exemplary outer socket 44h can be telescopically retracted by drawing the first socket portion 80h against the spring and into the second socket portion. The exemplary tubular sleeve member 52h can then be screwed onto the shank 14h, the threads of the tubular sleeve portion 60h threaded on the threads of the shank 14h. The tubular sleeve member 52h can be screwed onto the shank 14h until the tip or distal end of the driver portion 62h contacts the distal end of the shank 14h. The first socket portion 80h can then be released so that the output socket 44h telescopically expands and the female polygonal opening 50h mates with a nut 12h on the shank 14h. Rotation in a first rotational direction can then be input to an input member, resulting in the breaking of the engagement between the threads of the nut 12h and the threads of the shank 14h.

After the engagement between the threads of the nut 12h and the threads of the shank 14h is broken, the first socket portion 80h can be drawn back into the second socket portion to disengage the female polygonal opening 50h from the nut 12h and also to mate the female polygonal opening 50h with the second portion 130h. Rotation in a second rotational direction opposite to the first rotational direction can then be input to an input member, initially resulting in the first socket portion 80h unscrewing the tubular sleeve portion 60h from the shank 14h.

It is noted that in one or more embodiments of the present disclosure, the gearbox assembly can be configured to allow the first and second output members to turn in the same direction. This could be accomplished by sliding over of gears. Such an embodiment would be useful for tightening nuts. Such an embodiment could operate such that the input (wrench/drill side) could impart counterclockwise rotation to the input member and the gearbox assembly could output clockwise rotation through both of the first and second output members.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A fastener removal apparatus configured for removing a nut from a threaded shank and comprising:
a gearbox assembly having an input member, a first output member, a second output member, and a plurality of gears disposed between said input member and said first output member such that said first output member and said second output member rotation in opposite directions about a longitudinal axis in response to rotation imparted to said input member;
an outer socket extending along and centered on said longitudinal axis between a first end defining a female polygonal opening for mating with the fastening nut and a second end spaced from the first end along said longitudinal axis and engaged for concurrent rotation with said first output member; and
a tubular sleeve member surrounded by said outer socket, said tubular sleeve member extending along and centered on said longitudinal axis between a first end defining a threaded opening for receiving threads defined by the threaded shank and a second end spaced from the first end along said longitudinal axis and engaged for concurrent rotation with said second output member.

2. The fastener removal apparatus of claim 1 wherein said tubular sleeve member further comprises:
a tubular sleeve portion including said first end of said tubular sleeve member and said threaded opening; and
a driver portion including said second end of said tubular sleeve member and engaged for concurrent rotation with said second output member.

3. The fastener removal apparatus of claim 2 wherein said tubular sleeve portion and said driver portion are integrally-formed with respect to one another.

4. The fastener removal apparatus of claim 2 wherein said tubular sleeve portion and said driver portion are threadingly-engaged with respect to one another.

5. The fastener removal apparatus of claim 4 wherein said tubular sleeve portion and said driver portion are threadingly-engaged with respect to one another such that:
in response to rotation of said driver portion in a first rotational direction over at least some angular range, said tubular sleeve portion is driven in said first rotational direction; and
in response to rotation of said driver portion in a second rotational direction opposite to said first rotational direction over said at least some angular range, said tubular sleeve portion is not driven in said second rotational direction.

6. The fastener removal apparatus of claim 5 wherein said at least some angular range is further defined as a one-quarter or less turn of said driver portion.

7. The fastener removal apparatus of claim 5 further comprising:
a pin extending perpendicular to said longitudinal axis and passing through at least part of said tubular sleeve portion and said driver portion, wherein one of said tubular sleeve portion and said driver portion receives said pin in a slot that extends around said longitudinal axis.

8. The fastener removal apparatus of claim 5 wherein, in a cross-section perpendicular to said longitudinal axis, for at least some length of overlap of said tubular sleeve portion and said driver portion along said longitudinal axis, a radial gap is defined between said tubular sleeve portion and said driver portion, said radial gap extending an angular distance about said longitudinal axis less than three hundred and sixty degrees, one of said tubular sleeve portion and said driver portion defines a first shoulder and a second shoulder each extending radially with respect to said longitudinal axis and spaced from one another about said longitudinal axis and thereby defining said angular distance of said radial gap, and the other of said tubular sleeve portion and said driver portion defines a protuberance extending radially in said radial gap between said first shoulder and said second shoulder.

9. The fastener removal apparatus of claim 8 wherein said other of said tubular sleeve portion and said driver portion that defines said protuberance further comprises:
a base portion radially inward of said protuberance and having a first slot;
a second slot fixedly associated with said protuberance; and
a key selectively insertable in both of said first slot and said second slot concurrently to selectively lock said base portion and said protuberance.

10. The fastener removal apparatus of claim 9 wherein said protuberance is further defined as a corner.

11. The fastener removal apparatus of claim 4 wherein said tubular sleeve portion and said driver portion are threadingly-engaged through a first pair of mating threads and a second pair of mating threads such that:
in response to rotation of said driver portion in a first rotational direction over a first angular range, said driver portion and said tubular sleeve portion are threadingly-engaged only through said first pair of mating threads and said tubular sleeve portion is not driven in said first rotational direction; and
in response to rotation of said driver portion in said first rotational direction beyond said first angular range, said driver portion and said tubular sleeve portion are threadingly-engaged through both of said first pair of mating threads said second pair of mating threads and said tubular sleeve portion is driven in said first rotational direction.

12. The fastener removal apparatus of claim 11 wherein said first pair of mating threads and said second pair of mating threads have different diameters.

13. The fastener removal apparatus of claim 4 wherein said tubular sleeve member further comprises:
a plurality of bearings mounted in one of said tubular sleeve portion and said driver portion and operably disposed between said tubular sleeve portion and said driver portion.

14. The fastener removal apparatus of claim 2 further comprising:
a mounting post disposed at an end of said driver portion opposite to said second end of said tubular sleeve member and being at least partially spherical;
a landing plate disposed on said mounting post, said landing plate defining a recess receiving at least a portion of said mounting post on first side and a substantially flat surface on a second side opposite said first side, said landing plate configured to swivel relative to said mounting post.

15. The fastener removal apparatus of claim 2 wherein said tubular sleeve member further comprises:
a blind aperture defined by said tubular sleeve portion in cooperation with said driver portion, said blind aperture centered on said longitudinal axis and open toward said first end and having a floor; and
a protuberance projecting along said longitudinal axis away from said floor toward said threaded opening, said protuberance having tip spaced from said floor and said tip having a diameter smaller than a diameter of said blind aperture.

16. The fastener removal apparatus of claim 1 wherein said outer socket further comprises:
a first socket portion including said first end of said outer socket and said female polygonal opening; and
a second socket portion including said second end of said outer socket and engaged for concurrent rotation with said first output member, wherein said first socket portion and said second socket portion are telescopically engaged with one another.

17. The fastener removal apparatus of claim 16 wherein said tubular sleeve member further comprises:
a tubular sleeve portion including said first end of said tubular sleeve member and said threaded opening; and
a driver portion including said second end of said tubular sleeve member and engaged for concurrent rotation with said second output member, wherein at least part of an outer surface of said tubular sleeve portion is sized and shaped to mate with said female polygonal opening.

18. The fastener removal apparatus of claim 17 wherein said outer surface of said tubular sleeve portion includes:
a first portion extending a first length along said longitudinal axis and having a circular cross-section with an outer diameter smaller than said female polygonal opening; and
a second portion extending a second length along said longitudinal axis and defining said part of said outer surface of said tubular sleeve portion that is sized and shaped to mate with said female polygonal opening.

19. The fastener removal apparatus of claim 18 wherein said first portion is closer to said female polygonal opening along said longitudinal axis when said first socket portion and said second socket portion are fully telescopically extended with respect to one another.

20. The fastener removal apparatus of claim 18 wherein said female polygonal opening extends a third length along said longitudinal axis and wherein said first length is not greater than said third length.
